(19) United States
(12) Patent Application Publication
(10) Pub. No.: US 2007/0220185 A1
(43) Pub. Date: Sep. 20, 2007

(54) METHODS AND APPARATUSES FOR SELECTIVELY REBUFFERING AND DECODING A PORTION OF A DATA BLOCK READ FROM AN OPTICAL STORAGE MEDIUM

(76) Inventors: Li-Lien Lin, Hsin-Chu City (TW); Ping-Sheng Chen, Chia-Yi Hsien (TW); Shih-Hsin Chen, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/749,735

(22) Filed: May 16, 2007

Related U.S. Application Data
(62) Division of application No. 10/907,655, filed on Apr. 11, 2005.

(51) Int. Cl. G06F 5/00

(52) U.S. Cl. 710/52

(57) ABSTRACT

An apparatus for selectively rebuffering at least a portion of a data block read from an optical storage medium. The apparatus comprises a storage device for buffering the data block, and a rebuffering control module for rebuffering a specific portion into the storage device according to a previous decoding result, and thereby updating the buffered data block.

### CROSS REFERENCE TO RELATED APPLICATIONS

This is a division of application Ser. No. 10/907,655, filed Apr. 11, 2005, from which the specification and drawings are carried forward without amendment, and which is included herein by reference.

### BACKGROUND

The present invention relates to an optical storage device, and more particularly, to methods and apparatuses for selectively rebuffering at least a portion of a data block read from an optical storage medium, and methods and apparatuses for decoding a data block read more than once from an optical storage medium.

As multimedia applications progress prosperously, the demand for storing massive digital data increases rapidly. As a result, high storage volume and compact size optical storage media such as Compact Discs (CDs) and Digital Versatile Discs (DVDs) become more and more popular, and a drive such as a CD or DVD drive becomes a standard accessory of a personal computer (PC) utilized for performing the multimedia applications.

The data recorded on a conventional CD, such as a CD-Recordable (CD-R) disc, is usually encoded in units of sectors. To read the data on the CD, a conventional CD drive usually decodes the data in units of sectors. For some other optical storage mediums such as a DVD-R disc or a DVD+R disc, the decoding unit is an Error Correction Code (ECC) block composed of a plurality of sectors, for example, 16 sectors. According to High-Definition DVD (HD-DVD) specifications, the decoding unit for an HD-DVD is also an ECC block composed of a plurality of sectors, for example, 32 sectors. Yet according to Blu-ray Disc (BD) specifications, the decoding unit for a BD is a cluster composed of a plurality of sectors, for example, 32 sectors. As a result, an optical disc drive for accessing a DVD/HD-DVD/BD is supposed to buffer data of a size corresponding the decoding unit thereof read from the DVD/HD-DVD/BD for further decoding.

### SUMMARY

It is an objective of the claimed invention to provide methods and apparatuses for selectively rebuffering at least a portion of a data block read from an optical storage medium, and methods and apparatuses for decoding a data block composed of portions read from an optical storage medium.

An embodiment of an apparatus for selectively rebuffering at least a portion of a data block read from an optical storage medium comprises a storage device and a rebuffering module. The storage device buffers the data block for decoding. The rebuffering control module coupled to the storage device determines a specific portion of the data block requiring of rebuffering based on previous decoding, and rebuffers the specific portion into the storage device thereby updating the buffered data block.

An embodiment of a method for selectively rebuffering at least a portion of a data block read from an optical storage medium comprises buffering the data block for decoding, determining a specific portion of the data block requiring of rebuffering based on previous decoding, and rebuffering the specific portion thereby updating the buffered data block.

An embodiment of an apparatus for decoding a data block read from an optical storage medium comprises a storage device and a decoding module. The storage device orderly stores a first buffered data and a second buffered data through buffering the same data block read from the optical storage medium at different times, wherein the first buffered data is not overwritten by the second buffered data. The decoding module coupled to the storage device comprises a storage unit and a decoder. The storage unit stores a parameter for indicating whether each portion or at least a portion of the first buffered data is correctly decoded. The decoder coupled to the storage unit decodes the data block utilizing the first and second buffered data according to the parameter.

According to a variation of this embodiment, the storage device is capable of orderly storing more than two sets of buffered data through buffering the same data block read from the optical storage medium more than twice. The parameter can be utilized for indicating whether one or more sets of buffered data are correctly decoded, and the decoder is capable of decoding the data block utilizing more than two sets of buffered data according to the parameter.

An embodiment of a method for decoding a data block read from an optical storage medium comprises orderly storing a first buffered data and a second buffered data through buffering the same data block read from the optical storage medium at different times, wherein the first buffered data is not overwritten by the second buffered data. The embodiment of the method further comprises determining a parameter for indicating whether each portion or at least a portion of the first buffered data is correctly decoded, and decoding the data block utilizing the first and second buffered data according to the parameter.

According to a variation of this embodiment, the step of orderly storing the first and second buffered data further comprises orderly storing more than two sets of buffered data through buffering the same data block read from the optical storage medium more than twice, the parameter can be utilized for indicating whether one or more sets of buffered data are correctly decoded, and the step of decoding the data block further comprises decoding the data block utilizing more than two buffered data according to the parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an apparatus for selectively rebuffering at least a portion of a data block read from an optical storage medium according to one embodiment of the present invention.

FIG. 2 illustrates a data block stored in an optical storage medium and a buffered data block in a storage device as shown in FIG. 1, where a single sector can be updated individually according to the embodiment.

FIG. 3 illustrates a data block stored in an optical storage medium and a buffered data block in a storage device, where a codeword can be updated one at a time according to a variation of the embodiment.

FIG. 4 is a block diagram of an apparatus for selectively rebuffering at least a portion of a data block read from an optical storage medium according to another embodiment of the present invention.

FIG. 5 illustrates de-interleaved data corresponding to a data block and a buffered data block in a DRAM.

FIG. 6 is a block diagram of an apparatus for decoding a data block composed of portions read from an optical storage medium according to one embodiment of the present invention.

FIG. 7 illustrates a data block stored in the optical storage medium and the data block multi-buffered in a DRAM.

### DETAILED DESCRIPTION

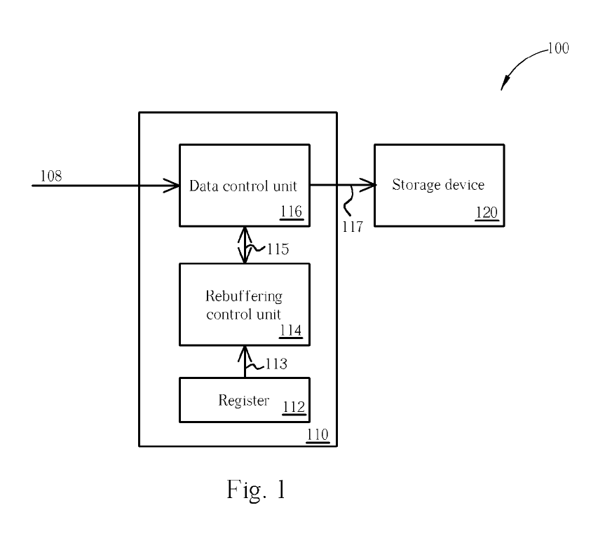

FIG. 1 is a diagram of an apparatus 100 for selectively rebuffering at least a portion of a data block read from an optical storage medium according to a first embodiment of the present invention, where the optical storage medium is a DVD and the data block is an error correction code (ECC) block in this embodiment. The apparatus 100 is positioned in an optical storage device such as a DVD drive for buffering the data block read from the optical storage medium for decoding. The apparatus 100 comprises a rebuffering control module 110 and a storage device 120, such as a Dynamic Random Access Memory (DRAM), where the storage device 120 is utilized for buffering the data block for decoding. In addition, the rebuffering control module 110 determines a specific portion of the data block requiring of rebuffering based on previous decoding of the data block, and rebuffers the specific portion into the storage device 120 to update the buffered data block.

As shown in FIG. 1, the rebuffering control module 110 comprises a storage unit such as a register 112 for storing a parameter determined by the rebuffering control module 110, where the parameter is utilized for recording whether each portion or at least a portion of the data block is correctly decoded, and the rebuffering control module 110 determines the specific portion according to the parameter. In some embodiments, the parameter is determined according to a command generated by a micro-processing unit (MPU) or a decoder such as an ECC decoder in the DVD drive. Additionally, the rebuffering control module 110 further comprises a rebuffering control unit 114 and a data control unit 116. In this embodiment, a demodulation circuit (not shown) of the DVD drive generates a demodulated signal 108 according to data read from the DVD. The rebuffering control module 110 is capable of receiving the demodulated signal 108 through the data control unit 116, where the data control unit 116 de-interleaves or rearranges the data block read from the DVD before transferring the data block to the DRAM 120. In addition, the data control unit 116 is capable of buffering the data read from the DVD into the DRAM 120 in a normal mode or rebuffering the data read from the DVD into the DRAM 120 in a rebuffering mode according to control of the rebuffering control unit 114.

In the normal mode, the data control unit 116 transfers the data block with data de-interleaved or rearranged to the DRAM 120, and typically, by the operation of the data control unit 116, the content recorded on the DVD can be sequentially buffered into the DRAM 120 for decoding. If a decoding error occurs, the apparatus 100 switches from the normal mode to the rebuffering mode. In the rebuffering mode, the rebuffering control unit 114 generates a control signal 115 according to a parameter 113 stored in the register 112. The parameter 113 of some embodiments comprises one or more data locations and one or more results from previous decoding. The data control unit 116 rebuffers the specific portion according to the control signal 115. The result from previous decoding is typically derived from error detection codes (EDC) in the data block. In this embodiment, the parameter comprises a plurality of bits respectively corresponding to data locations within the data block, where each bit of the parameter 113 can be considered to be a flag. In addition, the value of each bit can be utilized for representing the previous decoding result corresponding to a specific data location, so the parameter 113 represents information of both data locations and previous decoding results. The rebuffering control unit 114 controls the data control unit 116 with the control signal 115 derived from the parameter 113.

It is noted that according to the present invention, whether the rebuffering control module 110 generates one or more parameters 113 is not a limitation. In a variation of the first embodiment, the rebuffering control module 110 generates a plurality of parameters, where each of the parameters corresponds to a data location within the data block, and is utilized for recording whether a portion of the data block is correctly decoded. In addition, each parameter mentioned above may comprise one or more bits. Additionally, the number of parameters is not necessary to equal to the number of the data locations. The parameter or parameters comprise sufficient information and therefore are capable of being utilized for recording whether each portion of the data block is correctly decoded.

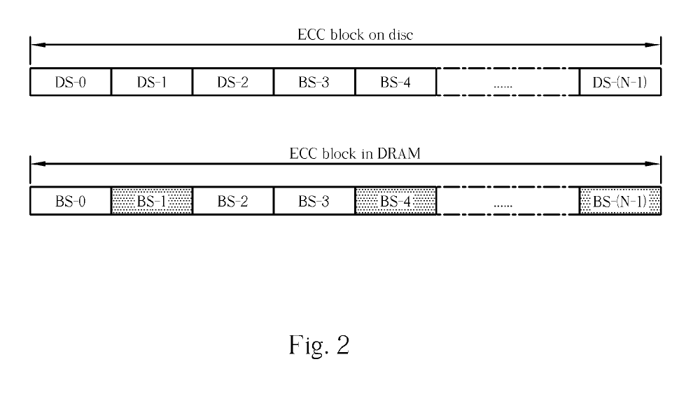

FIG. 2 illustrates an ECC block stored on the DVD and a buffered ECC block stored in the DRAM 120 shown in FIG. 1 according to the first embodiment, where the ECC block stored in the DVD comprises a plurality of sectors DS-0, DS-1, DS-2, . . . , DS-(N−1), the buffered ECC block comprises a plurality of sectors BS-0, BS-1, BS-2, . . . , BS-(N−1) respectively corresponding to the sectors DS-0, DS-1, DS-2, . . . DS-(N−1), and N is equal to 16 for DVD. The register 112 of FIG. 1 stores the parameter 113 comprising the afore-mentioned flags respectively corresponding to portions such as sectors DS-0, DS-1, DS-2, DS-(N−1) or sectors BS-0, BS-1, BS-2, . . . , BS-(N−1). Each of the flags is utilized for indicating whether a corresponding portion needs to be rebuffered. Initial values of the flags can be determined utilizing the MPU by executing a firmware code to indicate the initial state of the rebuffering control module 114, so the rebuffering control module 114 buffers the entire ECC block into the DRAM 120 in a first time. After decoding the ECC block, a decoder generates the previous decoding results of the ECC block (for example, utilizing the information of the EDC mentioned above). The MPU executing the firmware code determines the latest values of the flags stored in the register 112 to indicate whether each sector BS-0, BS-1, BS-2, . . . , BS-(N−1) requires rebuffering. Please note that the parameter can be determined by the rebuffering control module 110 according to the previous decoding results or by utilizing the MPU to execute the firmware code.

The flags represent the correctness of buffered sectors BS-0, BS-1, BS-2, . . . , BS-(N−1), respectively. The values of the flags can be determined according to the previous decoding results of the ECC block. For example, if the sectors BS-1, BS-4, and BS-(N−1) buffered at the first time are erroneous after decoding the ECC block, the flags will be adjusted to indicate that sectors BS-1, BS-4, and BS-(N−1) are incorrect and need to be rebuffered. Here, doted patterns are utilized for representing the erroneous sectors. The DVD drive thus read sectors DS-1, DS-4, and DS-(N−1) again for rebuffering. The rebuffering control unit 114 generates the control signal 115 to notify the data control unit 116, so the data control unit 116 rebuffers sectors DS-1, DS-4, and DS-(N−1) read from the DVD into the DRAM 120 to update sectors BS-1, BS-4, and BS-(N−1). The ECC decoder may decode the ECC block again according to the latest content of the buffered ECC block in the DRAM 120. Furthermore, the smallest unit for rebuffering is not necessary to be a sector, as the sector may be further segmented into smaller portions. In the same way, if the parameter is capable of indicating which portion in each sector is erroneous after decoding, the data control unit 116 may updates at least a portion of sectors BS-1, BS-4, and BS-(N−1) according to at least one latest decoding result of the ECC block. As a result, the total time required for successfully decoding the ECC block can be shorten since rebuffering the whole ECC block is not needed according to this embodiment.

Please note, continuously reading the sectors DS-0, DS-1, DS-2, DS-3, and DS-4 could be faster than reading the erroneous sectors (DS-1 and DS-4) separately according to a trial experiment. As the firmware code can be varied accordingly, the MPU may control the DVD drive to read sectors DS-0, DS-1, DS-2, DS-3, and DS-4 again after first decoding although rebuffering sectors BS-0, BS-2 and BS-3 is not needed in such situation. In addition, according to another trial experiment, if continuously rebuffering sectors BS-0, BS-1, BS-2, BS-3, and BS-4 is generally faster than only rebuffering the erroneous sectors (BS-1 and BS-4), the firmware code can be varied accordingly, so the rebuffering control module 110 rebuffers sectors BS-0, BS-1, BS-2, BS-3, and BS-4 according to the flags of the parameter although rebuffering sectors BS-0, BS-2 and BS-3 is not needed in such situation. Permanent damage to the ECC block may exist. In that case, it may be desirable to utilize a predetermined threshold to indicate a limited number of times that the rebuffering control module 110 rebuffers the same ECC block.

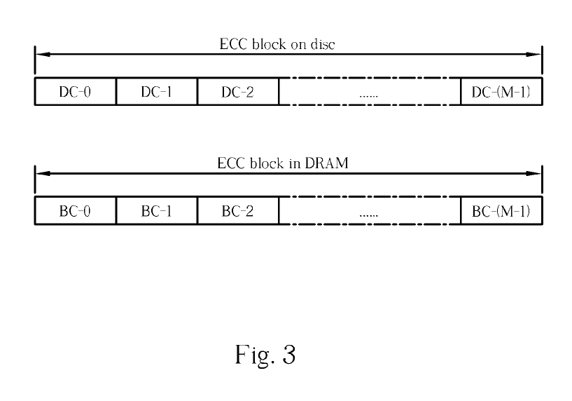

FIG. 3 illustrates an ECC block stored on a DVD and a buffered ECC block in a DRAM according to a variation of the first embodiment, where the rebuffering control module 110 is capable of updating a portion comprising at least one codeword. In this variation, the flags of the parameter represent correctness of the decoded codewords BC-0, BC-1, BC-2, . . . , BC-(M−1), respectively. Similarly, the rebuffering control unit 114 generates at least one control signal 115 according to the parameter to notify the data control unit 116. As a result, the data control unit 116 may update a specific codeword according to a specific flag of the parameter. Please note that portions of various lengths may be applied to other embodiments of the present invention. For example, if a portion comprises two or more codewords then the number of flags of the parameter may be reduced.

In another embodiment of the present invention, a data block decoder such as the ECC decoder, further functions in determining the value of the parameter for indicating whether the portions in the data block requires of rebuffering, respectively. The storage unit for storing the parameter can be positioned in the ECC decoder or in the MPU, depending on various implementation choices of the present invention.

In another embodiment of the present invention, the optical storage medium is a High Definition DVD (HD-DVD), where the value N shown in FIG. 2, i.e. the number of sectors in a data block according to HD-DVD specifications, may vary accordingly. In addition, the value M shown in FIG. 3 can be redefined accordingly. Similar descriptions for the HD-DVD are not repeated herein.

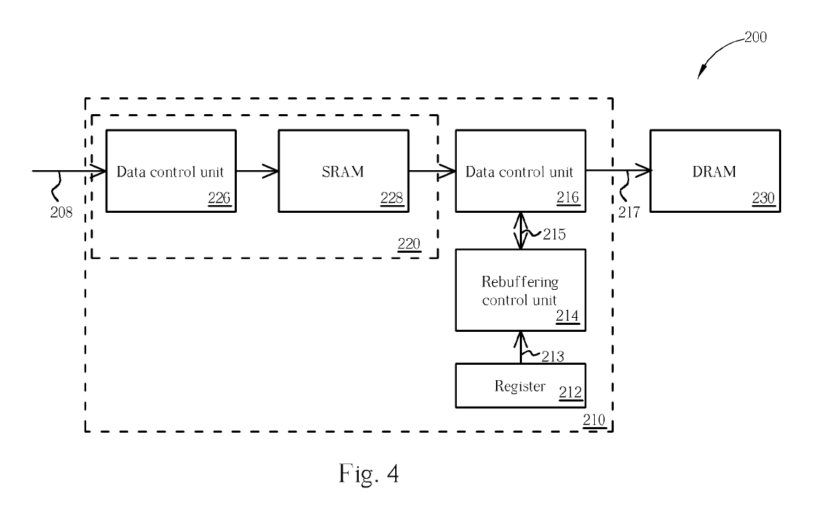

FIG. 4 is a block diagram of another apparatus 200 for selectively rebuffering at least a portion of a data block read from an optical storage medium according to a second embodiment of the present invention, where the optical storage medium is a Blu-ray disc (BD) and the data block is a cluster. The apparatus 200 comprises a rebuffering control module 210 and a DRAM 230. As shown in FIG. 4, the rebuffering control module 210 comprises a register 212, a rebuffering control unit 214, a first data control unit 216, and a de-interleaving circuit 220, where the de-interleaving circuit 220 comprises a second data control unit 226 and an intermediate buffer, which is a Static Random Access Memory (SRAM) 228 in this embodiment. The functionalities of the register 212, the rebuffering control unit 214, and the first data control unit 216 are similar to those of the register 112, the rebuffering control unit 114, and the data control unit 116 of FIG. 1. The second data control unit 226 de-interleaves the data block read from the BD, and the SRAM 228 is utilized for buffering and transferring the de-interleaved data block from the second data control unit 226 to the first data control unit 216.

In this embodiment, the second data control unit 226 receives clusters read from the BD through a demodulated signal 208 generated by a demodulation circuit (not shown) of a BD drive. De-interleaving and rearrangement of the clusters read from the BD is well known in the art, and therefore not explained in detail herein.

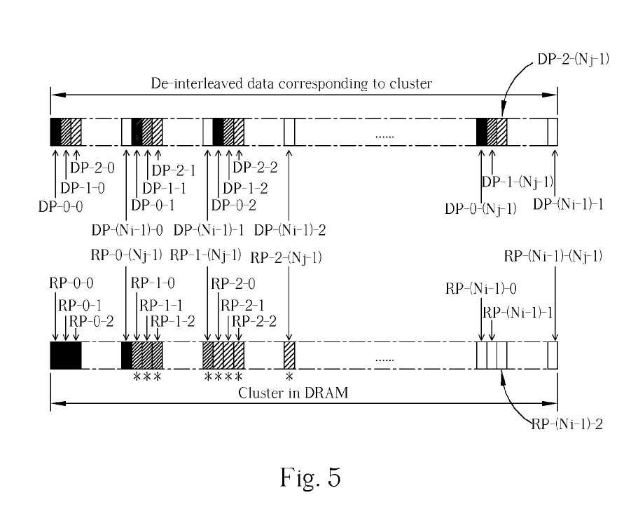

FIG. 5 illustrates de-interleaved data corresponding to a cluster, which comprises codewords, and a buffered cluster stored in a DRAM (for example, the DRAM 230 in FIG. 4), where it is possible to update only a portion of a cluster at a time according to this embodiment. In this embodiment, the de-interleaved data is stored in an SRAM (for example, the SRAM 228 in FIG. 4). Please note that the de-interleaved data is not necessary to be stored in the SRAM according to a variation of this embodiment. As a result of the rearrangement performed by a data control unit, such as the data control unit 216 in FIG. 4, each portion RP-I-J (I=0, 1, . . . , or Ni, and J=0, 1, . . . , or Nj) of the buffered cluster corresponds to a portion DP-I-J of the de-interleaved data, where Ni and Nj can be determined to be specific values, respectively, according to specifications. Here a sector I comprises portions RP-I-0, RP-I-1, RP-I-2, . . . , and RP-I-(Nj−1). In this embodiment, a parameter comprising a plurality of flags indicates whether each of portions RP-I-J (I=0, 1, . . . , and Ni, and J=0, 1, . . . , and Nj) needs to be rebuffered, respectively. The meaning of the parameter, variations thereof, and the method for generating the parameter are disclosed in the first embodiment and therefore not repeated here. If the flags of the parameter indicate that specific sectors of the buffered cluster in the DRAM need to be rebuffered, the rebuffering control module (for example, the rebuffering control module 210 in FIG. 4) rebuffers the portions corresponding to the specific sectors into the DRAM to update the buffered cluster. For example, an MPU executing a firmware code in the BD drive determines that the sector corresponding to portions RP-1-0, RP-1-1, RP-1-2, . . . , and RP-1-(Nj−1), and the sector corresponding to portions RP-2-0, RP-2-1, RP-2-2, . . . , and RP-2-(Nj−1) are incorrect according to the decoding result of the buffered cluster. Here, the incorrect portions are marked with “*” as shown in FIG. 5. As the MPU executing the firmware code may determine values of the flags of the parameter accordingly, the rebuffering control module rebuffers portions DP-1-0, DP-1-1, DP-1-2, . . . , and DP-1-(Nj−1), and portions DP-2-0, DP-2-1, DP-2-2, . . . , and DP-2-(Nj−1) into the DRAM according to the flags to update portions RP-1-0, RP-1-1, RP-1-2, . . . , and RP-1-(Nj-1), and portions RP-2-0, RP-2-1, RP-2-2, . . . , and RP-2-(Nj−1). Similarly, the rebuffering control module 210 may rebuffer the erroneous part of portions DP-1-0, DP-1-1, DP-1-2, . . . , and DP-1-(Nj−1), and portions DP-2-0, DP-2-1, DP-2-2, . . . , and DP-2-(Nj−1) into the DRAM instead of rebuffering the entire sector. In addition, the number of times that the rebuffering control module may rebuffer the same cluster can be limited according to a predetermined threshold. Variations related to this embodiment are not repeated herein.

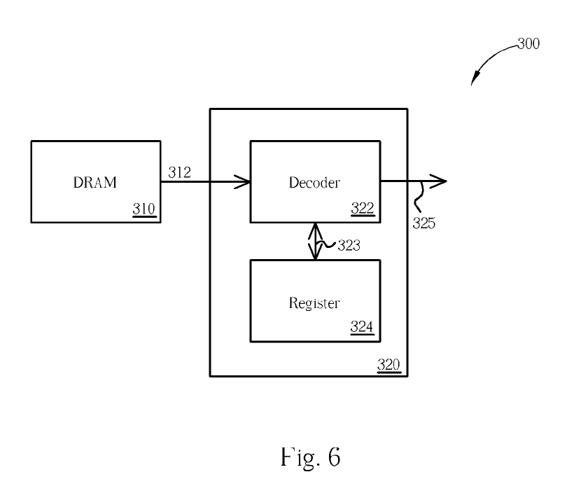

FIG. 6 is a block diagram of an apparatus 300 for decoding a data block composed of portions read from an optical storage medium according to one embodiment of the present invention. In this embodiment, the optical storage medium is a DVD and the data block is an ECC block. The apparatus 300 comprises a storage device, which is a DRAM 310 in this embodiment, and a decoding module 320. As shown in FIG. 6, the decoding module 320 comprises a decoder 322 and a storage unit such as a register 324. Similar to the register 112 shown in FIG. 1, the register 324 can be positioned in different locations in the optical drive according to various implementation choices. In this embodiment, the register 324 stores a parameter. The parameter in the register 324 may indicate which portion of the buffered data corresponding to the same ECC block stored in the DVD should be read again by the decoder 322. Similar variations of the meaning of the parameter(s), e.g. the variations of the parameter comprising a plurality of flags respectively having a single bit or a plurality of bits for each portion of the ECC block, or the parameter indicating the positions of erroneous portions, are applicable to other embodiments of the present invention.

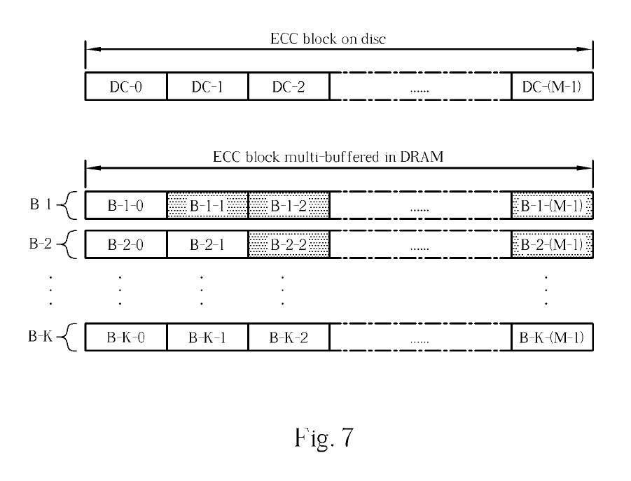

FIG. 7 illustrates an ECC block stored on a DVD and the ECC block multi-buffered in a DRAM (for example, the DRAM 310 as shown in FIG. 6). The DRAM orderly stores buffered data B-1, B-2, . . . , and B-K through buffering the same ECC block read from the DVD at different times, where the buffered data B-1, B-2, . . . , and B-K do not overwrite one another. Here the same ECC block is buffered K times into the DRAM. A memory, such as the register 324 of FIG. 6 stores a parameter composed of flags corresponding to portions DC-0, DC-1, DC-2, . . . DC-(M−1) of the ECC block. Each flag is utilized for indicating whether a portion of the buffered data B-1 is incorrectly decoded. Here, each flag comprises a plurality of bits thereby storing sufficient information for indicating which of the buffered data B-1, B-2, . . . , and B-K can be utilized for decoding. The decoder 322 is capable of decoding the ECC block utilizing the buffered data B-1, B-2, . . . , and B-K according to the flags.

In this embodiment, the decoder 322 is an ECC decoder. After the buffered data B-1 is stored in the DRAM 310, the decoder 322 decodes the buffered data B-1 to generate a decoding result. Then a controller such as the MPU determines values of the flags of the parameter according to the decoding result from decoding the buffered data B-1, and more particularly, according to correctness of each portion of the decoded data block after decoding the buffered data B-1, so the parameter indicates whether each portion B-1-0, B-1-1, B-1-2, B-1-(M−1) is incorrectly decoded. For example, if portions B-1-1, B-1-2, . . . , B-1-(M−1) as shown in FIG. 7 with dotted pattern are incorrectly decoded, the buffered data B-2 is stored in the DRAM 310. According to the parameter, the decoder 322 decodes the ECC block according to portion B-1-0 of the buffered data B-1 and according to the portions B-2-1, B-2-2, . . . , B-2-(M−1) of the buffered data B-2 to generate at least one decoding result. Again, the MPU determines the values of the flags of the parameter according to the latest decoding result, and the parameter indicates whether the portions B-1-0, B-2-1, B-2-2, . . . , B-2-(M−1) are incorrectly decoded, respectively. For example, the portions B-2-2, . . . , B-2-(M−1) are incorrectly decoded, then the buffered data B-3 is stored in the DRAM 310. In the same way, the decoder 322 may decode the ECC block successfully if there exists, in the buffered data B-1, B-2, . . . , B-K, at least one correct portion corresponding to each of the portions DC-0, DC-1, DC-2, . . . , DC-(M−1) stored on the DVD. Similarly, the number of buffered data for the same cluster, i.e. K, can be limited according to a predetermined threshold.

Please note that the portions DC-0, DC-1, DC-2, . . . , DC-(M−1) may be codewords in this embodiment. Various portions of other lengths can be applied to other embodiments of the present invention. For example, if a portion comprises two or more codewords, then the number of flags or bits of the parameter can be reduced. According to another embodiment of the present invention, a portion may comprise a sector.

In a variation of the embodiment shown in FIG. 6, the decoder 322 is capable of determining the value of the parameter according to the correctness of the portions in the buffered data B-1, B-2, . . . , and B-K. Additionally, in other variations of the embodiment shown in FIG. 6, the optical storage medium can be an HD-DVD or a BD, and/or the data block can be a cluster corresponding to the optical storage medium accordingly. Similar descriptions related to these variations are not repeated herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for decoding a data block composed of portions read from an optical storage medium, comprising:
a storage device for orderly storing a first buffered data and a second buffered data through buffering the same data block read from the optical storage medium at different times, wherein the first buffered data is not overwritten by the second buffered data; and
a decoding module coupled to the storage device, comprising:
a storage unit for storing a parameter for indicating whether each portion or at least a portion of the first buffered data is correctly decoded; and
a decoder coupled to the storage unit for decoding the data block utilizing the first and second buffered data according to the parameter.

2. The apparatus of claim 1, wherein if the parameter indicates that a specific portion of the first buffered data is incorrectly decoded, the decoder is capable of decoding the data block utilizing a corresponding portion of the second buffered data.

3. The apparatus of claim 1, wherein the decoder determines the parameter according to a result from decoding the first buffered data.

4. The apparatus of claim 1, further comprising:
a controller for determining the parameter according to correctness of each portion or at least a portion of the decoded data block after decoding the first buffered data.

5. The apparatus of claim 4, wherein the controller comprises a micro-processing unit (MPU).

6. The apparatus of claim 1, wherein the portion of the data block comprises at least a sector, at least a codeword, or a part of a sector or codeword within the data block.

7. A method for decoding a data block composed of portions read from an optical storage medium, comprising:
(a) orderly storing a first buffered data and a second buffered data through buffering the same data block read from the optical storage medium, wherein the first buffered data is not overwritten by the second buffered data;
(b) determining a parameter for indicating whether each portion or at least a portions of the first buffered data is correctly decoded; and
(c) decoding the data block utilizing the first and second buffered data according to the parameter.

8. The method of claim 7, wherein step (c) further comprises:
if the parameter indicates that a specific portion of the first buffered data is incorrectly decoded, decoding the data block utilizing a corresponding portion of the second buffered data.

9. The method of claim 7, wherein step (b) further comprises:
determining the parameter according to a result from decoding the first buffered data.

10. The method of claim 7, further comprising:
determining the parameter according to correctness of each portion or at least a portion of the decoded data block after decoding the first buffered data.

11. The method of claim 7, wherein the portion of the data block comprises at least a sector, at least a codeword, or a part of a sector or codeword within the data block.
